(19) United States
(12) Patent Application Publication
(10) Pub. No.: US 2006/0259555 A1
(43) Pub. Date: Nov. 16, 2006

(54) Systems and methods for creating and/or utilizing virtual automated agents

(75) Inventors: Khaled Hassounah, Charlestown, MA (US); Tom Harwood, Waltham, MA (US)

Correspondence Address: WILMER CUTLER PICKERING HALE AND DORR LLP, 1875 PENNSYLVANIA AVE., NW, WASHINGTON, DC, 20004, US

(73) Assignee: IMlogic, Inc., Waltham, MA (US)

(21) Appl. No.: 11/129,486

(22) Filed: May 16, 2005

(51) Int. Cl. G06F 15/16

(52) U.S. Cl. 709/206

(57) ABSTRACT

The present invention generally relates to systems and methods for utilizing a virtual automated agent, known as a bot, in an instant messaging network in a manner in which the bot can simulate its existence to one or more clients without having to exist on an instant messaging network. In one embodiment of the invention, a system can include a first proxy server having at least one registered automated agent, at least a first client communicating with the first proxy server, and a server maintaining presence data for the first client. The automated agent intercepts a contact list transmitted from the server to the first client, and the automated agent is added to the contact list, thereby enabling the automated agent to transmit a message to the client without transmitting the message through the server.

### BACKGROUND OF THE INVENTION

1. Field of the Invention

The present invention relates generally to systems and methods for utilizing a virtual automated agent, known as a bot, in an instant messaging network and, more particularly, to systems and methods that utilize a bot in a manner in which the bot can simulate its existence to a client without having to exist on an instant messaging network.

2. Background Description

Instant messaging (IM) systems, such America Online Corporation (AOL) Instant Messenger (AIM), MSN, and Yahoo! Messenger, were initially designed primarily for the consumer space, where ease of use and minimal configuration are primary objectives. Since its inception IM technology has, however, grown beyond the consumer space to the point where IM use today encompasses, for example, marketing, purchasing, and research applications.

As a result, IM buddies known as “bots” have been developed that are utilized to communicate and interact with other users without significant human intervention or control. As used herein, a bot is a program that is present on an IM network (usually by logging in), and is able to provide services to the users of that network by utilizing any set of available features, such as exchanging messages with those users and changing its status. A bot may behave like another user on system, and can have wide-ranging functionality. For example, a bot may generate poetry, tell jokes, facilitate making a flight reservation on an airline, perform search functions, retrieve data, report weather and/or send weather advisories. In order to utilize a bot, a user adds the bot to his or her buddy list, and opens a chat window with the bot. The user may then proceed to chat or interact with the bot. An IM feature known as a “buddy list” enables users to create, organize, and manage a list of online friends, family members, and co-workers on a personal computer (PC) and/or a mobile phone. A buddy list feature window enables users to see which contacts (i.e., “buddies”) are offline or busy, and which are online and ready for messaging. The buddy list thus enables users of the system to know which other users are available for a dialog.

Although current IM architectures have been useful in implementing bots for one-to-one functionality between the bot and a single user, bots have not been as useful in providing a multi-user experience. Current implementations of IM services utilizing bots have limits with regard to scalability, presence, privacy, and the ability of clients to add bots to their buddy list. These limitations are generally due to the existing methods and configurations for sharing live data about users currently on the service.

For example, standard IM systems utilize platforms that are scaled using a distributed model of data sharing, where multiple instant messaging platforms are connected such that data from all users of the IM service is exchanged between the various IM platforms. This configuration is inefficient, and is scalable for a limited number of IM platform servers. The distributed configuration is not sufficient for growing to a large numbers of users.

While current bots are able to communicate with and engage several different users at once, known IM architectures are unable to adapt a bot's response or performance for one user based with respect to how another user may be interacting with the bot. For example, a bot that is performing a search for one user and idle with respect to a second user will provide the same presence information to both users. It is not possible, though, to provide a different presence status to different users based on any business logic. As a result, standard automated IM bots are not capable of being used to construct an interactive community.

With regard to privacy, the bot is subject to the user's default privacy settings. If the user has a default privacy setting that blocks other users from seeing his/her presence, the bot will not be able to detect whether the user is online or offline. The bot will thus not be able to deliver presence-related services, or perform any processing based on the user coming online or going offline.

In addition, bots are usually subject to the limitations imposed by the network. Those limitations can include the maximum message rate per user, and the number of users to whose presence they can subscribe in order to get status change notifications.

Finally, standard bots acts like a normal user, and require a user to manually add the bot to his/her buddy list before the user can view the presence status of the bot and/or communicate with the bot. This means that when a new bot is rolled out, the administrator of that bot needs to send, for example, an email notifying potential users of the existence of the bot. Interested users need to then manually add the bot to their respective buddy lists. This process may not be entirely effective since, for example, users might inadvertently ignore such message and/or forget to add the bot to their buddy list.

Thus, we have discovered that heretofore-unaddressed needs exist for a solution that addresses the aforementioned deficiencies and inadequacies.

### SUMMARY OF THE INVENTION

The present invention provides systems and methods for utilizing a bot in a manner that can simulate its existence to a client without having to exist on an instant messaging (IM) network. Advantageously, embodiments of the present invention improve or provide a solution to at least the scalability, presence, privacy, and difficulty of adding a bot to a buddy list, problems discussed above.

Embodiments of the present invention are directed to new ways of creating and/or utilizing bots. By intercepting the communication between the client and a server, a virtual bot can simulate its existence to the client, without having to actually exist on the IM network, and thereby exist as a “virtual bot” (also referred to as an automated agent). The virtual bot can subsequently work in the same way a standard bot. For example, the virtual bot can send messages to and receive messages from the user, notify the user of its status changes, and/or execute any other functionality applicable to that network. This can be performed by the bot injecting messages that are sent to the client, as if they are coming from the server or servers.

In one exemplary use of the present invention, at least one embodiment of an instant messaging (IM) system includes a first proxy server having at least one registered automated agent, at least a first client communicating with the first proxy server, and a server that maintains presence data for the first client. The automated agent intercepts a contact list transmitted from the server to the first client, and the automated agent is added to the contact list, thereby enabling the automated agent to transmit a message to the first client without transmitting the message through the server.

The automated agent can provide a first status to the first client. The IM system can also include a second client that communicates with the first proxy server. The automated agent can provide a second status to the second client. The status provided to the first client may be different than the status provided to the second client.

The IM system can include a second proxy server. The automated agent can be registered with the second proxy server. The first proxy server and the second proxy server may share state information pertaining to the automated agent.

A method in accordance with an embodiment of the present invention includes registering an automated agent with a first proxy server. A first client communicates with the first proxy server, and a server maintains presence data for the first client. The automated agent intercepts a contact list transmitted from the server to the first client, and the automated agent is added to the contact list. The automated agent transmits a message to the client, without transmitting the message through the server.

The automated agent can provide a first status to the first client. A second client can also communicate with the proxy server, and the automated agent can provide a second status to the second client. The status of the first client can be different that the status of the second client.

The automated agent may also be registered with a second proxy server. State information pertaining to the automated agent can be shared between the first proxy server and the second proxy server.

Before explaining at least some embodiments of the invention in detail, it is to be understood that the invention is not limited in its application to the details of construction and to the arrangements of the components set forth in the following description or illustrated in the drawings. The invention is capable of other embodiments and of being practiced and carried out in various ways.

### BRIEF DESCRIPTION OF THE DRAWINGS

The Detailed Description including the description of a preferred structure as embodying features of the invention will be best understood when read in reference to the accompanying figures wherein:

FIG. 1 is a block diagram of an exemplary system and architecture of the present invention.

FIG. 2 is a diagram of an exemplary process flow diagram in accordance with the present invention, which also illustrates an overview of a method according to the present invention.

### DETAILED DESCRIPTION OF A PREFERRED EMBODIMENT OF THE INVENTION

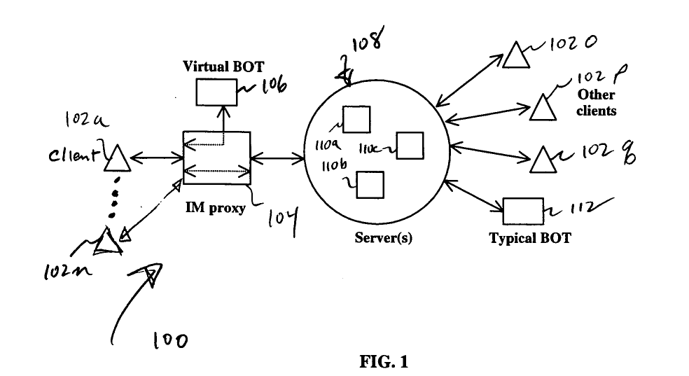

FIG. 1, generally at 100, is a block diagram of a system of an exemplary system and architecture of the present invention. The system 100, which in the embodiment shown in FIG. 1 consists of clients 102a-q which may be running, for example, on a standard desktop computer, laptop computer, and/or personal digital assistant (PDA). The devices may utilize either a wired or wireless connection to transmit and receive data. System 100 also includes proxy server 104, virtual bot 106, network 108 which can include various servers 110a-c, and standard bot 112.

Clients 102a-q can be applications that run, for example, on a standard personal computer and utilize a server 110a-c to perform some operations. In client-server architecture, client 102a-q software handles sending and receiving, while server 110a-c software handles sending and receiving for network 108. Servers 110a-c are computers or software applications that are generally accessed by other computers and/or clients 102a-q. Servers 110a-c can provide a specific kind of service to client 102a-q software running on other computers.

Proxy server 104 is positioned physically and/or logically between client 102a-n and servers 110a-c. Client 102a-n can be configured to use proxy server 104 as an instant messaging (IM) server. For example, client 102a can make requests to proxy server 104. In turn, proxy server 104 can make a request to one or more of servers 110a-c, and pass the result(s) back to client 102a-n.

Network 108 can consist of the Public Switched Telephone Network (PSTN), the Internet and/or a wireless network. Other network infrastructure can also be utilized. For example, the system 100 may also include a long distance network (LDN) operatively connected to the PSTN, and a terminating local PSTN operatively connected to the LDN.

There are various ways in which virtual bot 106 can intercept communication between client 102a-n and server 110a-c. For example, virtual bot 106 can be positioned physically and/or logically between, for example, client 102a and server 110a-c, and act as an intelligent proxy server. Virtual bot 106 can also utilize a separate proxy server 104. In these exemplary configurations, client 102a can connect to proxy server 104 in a standard manner. In turn, proxy server 104 establishes a connection with one or more of server(s) 110a-c. With this configuration, proxy server 104 can monitor communication and related traffic transmitted between client 102a and server 110a-c. In addition, proxy server 104 can also, for example, inject packets that it creates into the stream from client 102a to server 110a-c and/or from server 110a-c to client 102a.

Virtual bot 106 can communicate with server 110a-c and utilize, for example, a network protocol or an application program interface (API) of server 110a-c to monitor and manipulate traffic. Similarly, virtual bot 106 can communicate with client 102a, and utilize an API of client 102a to monitor and manipulate traffic.

A user of client 102a-n can start by adding virtual bot 106 to their contact list (e.g., buddy list), and then communicate with virtual bot 106 by sending messages to virtual bot 106. An IM feature known as a “buddy list” enables users to create, organize, and manage a list of online friends, family members, and co-workers on a PC and/or a mobile phone. A buddy list feature window enables users to see which contacts (i.e., “buddies”) are offline or busy, and which are online and ready for messaging. The buddy list thus enables users of the system to know which other users are available for a dialog.

To allow a user of client 102a-n to interact with virtual bot 106, virtual bot 106 can establish its presence on proxy server 104, and the user of client 102a-n can add virtual bot 106 to her/his buddy list. This can be accomplished in a standard manner, as may be done in accordance with various system protocols (e.g., AIM, MSN, etc.). Virtual bot 106 can establish its presence on proxy server 104 in a number of different ways. For example, virtual bot 106 could login to proxy server 104 in a same or similar manner as the user of client 102a-n would login to establish the presence of client 102a-n on proxy server 104. In addition, servers 110a-c can maintain, for example, a database or directory, of presentities respectively corresponding to one or more clients 102a-d. An exemplary presentity is an electronic identity consisting, for example, of a name, a password, and a presence status of a network entity. Further information pertaining to presentities is contained in the following Internet Engineering Task Force documents: 1) Request for Comment (RFC) 2778, dated February 2000, by M. Day et al., entitled A Model for Presence and Instant Messaging, and 2) RFC 2779, dated February 2000, by M. Day et al., entitled Instant Messaging/Presence Protocol Requirements. Copies of RFC 2778 and 2779 are incorporated herein by reference.

However, to allow a user of client 102a-n to interact with virtual bot 106, it may not be necessary for virtual bot 106 to establish its presence on proxy server 104, since IM protocols allow client 102a to send a message directly to another client 102o-q, virtual bot 106, and/or bot 112 without requiring client to be on their respective buddy lists.

Virtual bot 106 can add itself to the client 102a-n buddy list when the respective client 102a-n buddy list is sent from server 110a-c to client 102a-n. Therefore, in one or more embodiments of the present invention, no client (user) 102a action is required for client 102a-n to interact with virtual bot 106.

Virtual bot 106 can, for example, inject status change notifications to client 102a without having to go through server 110a-c. Virtual bot 106 can thus indicate the status of its presence to client 102a, without having an actual account on server 110a-c, and without having established presence on server 110a-c, by logging into that server 110a-c in a same or similar manner as standard bots do.

Virtual bot 106 can also receive messages that are transmitted by client 102a-n, before they are delivered to server 110a-c. Similarly, virtual bot 106 can transmit messages to client 102a-n, without the message having to be routed through server 110a-c. From the perspective of client 102a-n, messages transmitted to virtual bot 106 and received from virtual bot 106 work in the same way as if virtual bot 106 is logged into server 110a-c. However, server 110a-c advantageously does not receive traffic that is directed to virtual bot 106, since messages terminate at proxy server 104, prior to delivery to server 110a-c. Virtual bot 106 either directly, or in conjunction with proxy server 104, can provide, for example, the network packets utilized to communicate with client 102a-n.

More particularly, in one or more embodiments of the present invention, because virtual bot 104 injects its presence notification to each client 102a-n separately, virtual bot 106 has the ability to provide a different presence status to different clients 102a-n based on what notification respective clients 102a-n choose to inject. For example, virtual bot 106 could appear as “away” to client 102a, and appear as “on the phone” to clients 102b, 102e, and 102h, while appearing as “online” to other clients (e.g., clients 102c, 102d, etc.). This custom client 102a-n status could be utilized to communicate additional information to the respective end users of clients 102a-n (e.g., the status of a business transaction).

If the processing capacity of proxy server 104 is not sufficient to accommodate the number of clients 102a-n that will be logging in through it, one or more embodiments of the present invention can utilize two or more proxy servers 104 (e.g., proxy server 104a, and proxy server 104b) that each host virtual bot 106. In this embodiment of the present invention, multiple instances of virtual bot 106 can run independently of each of respective proxy servers (e.g., proxy server 104a, and proxy server 104b). Although there may be different instances of virtual bot 106, the different instances of virtual bot 106 can appear to client 102a-n as a single instance of virtual bot 106. For example, each instance of virtual bot 106a and 106b can have the same virtual bot 106 name. Clients 102a-n will therefore perceive that they are communicating with the same virtual bot 106, when they are actually communicating with different instances (e.g., virtual bot 106a, virtual bot 106b) of virtual bot 106. In one or more other embodiments of the present invention, virtual bots 106a, 106b can share state information, so that each instance (e.g., virtual bot 106a) is aware of the other bot instance(s) (e.g., virtual bot 106b). In this manner, virtual bot 106a is advantageously made aware of the communication that is occurring, via proxy server 104, between virtual bot 106b and any client(s) (e.g., clients 102b, 103h, and 102k) with which virtual bot 106b is communicating. Load balancing can also be performed across multiple instances of virtual bot 106 in a standard manner.

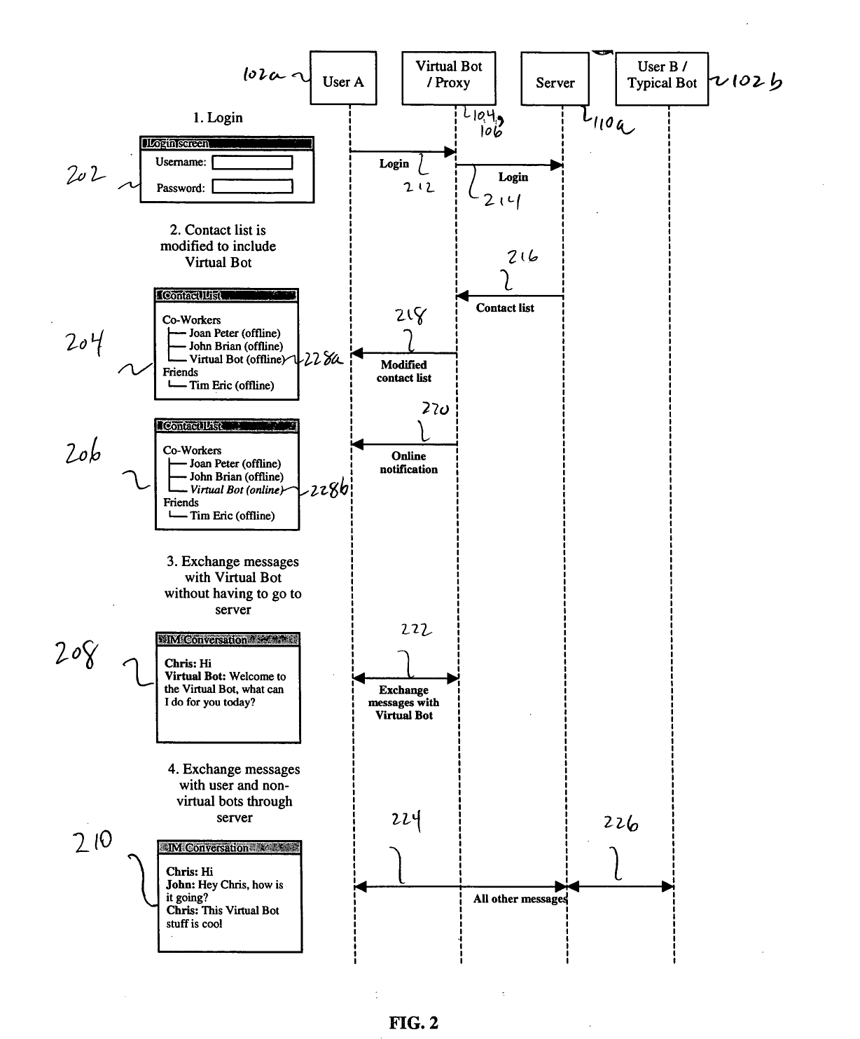

FIG. 2 is an exemplary process flow diagram in accordance with the present invention, which also illustrates an overview of a method according to the present invention. A user of client 102a-n can login 212 to client 102a-n using a screen display such as shown at 202. In particular, a user can provide a Username: and a Password: to log onto proxy server 104, which thereby connects client 102a to virtual bot 106. In turn, proxy server 104 logs in 214 to server 110a-c.

At 216, server 110a-c returns a contact list (e.g., a buddy list) to proxy server 104, at which point virtual bot 106 is added to the client 102a-n contact list. At 218, the modified contact list, that includes virtual bot 106, is transmitted to client 102a-n. An illustration of the modified contact list, as may be displayed on a standard monitor operating in connection with client 102a-n, is shown at 204. At or near the time that the modified contact list is transmitted to client 102a, server 110a can provide an indication of client 102a status to other clients (e.g., one or more of clients 102b-n and/or clients 102o-p). Once a client 102a-n is logged in to the server 110a and announces its status, server 110a can retrieve a list of other users that have announced an interest in the status of client 102a. If the other users (e.g., client 102b, 102d and/or 102p) are also connected to server 110a, then server 110a can provide the status of client 102a to client 102b, 102d and/or 102p.

At 220, virtual bot 106 can provide an indication to client 102a that the status of virtual bot 106 has changed from offline 228a to online 228b. At 222, messages can be exchanged between client 102a and virtual bot 106. A representative exchange of messages between client 102a-n and virtual bot 106 is shown at 208.

When client 102a wishes to communicate with clients 102b-q and/or bot 112, a message can be transmitted from client 102a to one or more of server(s) 110a-c. Then, server 110a-c transmits the message that originated from client 102a to the intended client 102b-q or bot 112.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what we claim as new and desire to secure by Letters Patent is as follows:

1. An instant messaging (IM) system, comprising:
a first proxy server having at least one registered automated agent;
at least a first client communicating with the first proxy server; and
a server maintaining presence data for the first client;
wherein the automated agent intercepts a contact list transmitted from the server to the first client, and the automated agent is added to the contact list, thereby enabling the automated agent to transmit a message to the first client without transmitting the message through the server.

2. The IM system according to claim 1, wherein the automated agent provides a first status to the first client.

3. The IM system according to claim 2, further comprising a second client communicating with the first proxy server.

4. The IM system according to claim 3, wherein the automated agent provides a second status to the second client.

5. The IM system according to claim 4, wherein the first status is a different status than the second status.

6. The IM system according to claim 1, further comprising a second proxy server, wherein the automated agent is registered with the second proxy server.

7. The IM system according to claim 6, wherein the first proxy server and the second proxy server share state information pertaining to the automated agent.

8. A method, comprising:
registering an automated agent with a first proxy server;
communicating, by a first client, with the first proxy server;
maintaining by a server presence data for the first client;
intercepting by the automated agent a contact list transmitted from the server to the first client;
adding the automated agent to the contact list; and
transmitting a message by the automated agent to the client without transmitting the message through the server.

9. The method according to claim 8, further comprising providing by the automated agent a first status to the first client.

10. The method according to claim 8, further comprising communicating, by a second client, with the proxy server.

11. The method according to claim 10, further comprising providing by the automated agent a second status to the second client.

12. The method according to claim 11, wherein the first status is a different status than the second status.

13. The method according to claim 8, further comprising registering the automated agent with a second proxy server.

14. The method according to claim 13, further comprising sharing state information, pertaining to the automated agent, between the first proxy server and the second proxy server.
